(19) United States
(12) Patent Application Publication
(10) Pub. No.: US 2024/0412379 A1
(43) Pub. Date: Dec. 12, 2024

(54) GENERATIVE FACIAL MAPPING AND BODY BLENDING DURING VIDEO CAPTURE

(71) Applicant: Emovid Corporation, Seattle, WA (US)

(72) Inventors: Digvijay Chauhan, Redmond, WA (US); Victor Cho, Burlingame, CA (US)

(21) Appl. No.: 18/735,893

(22) Filed: Jun. 6, 2024

Related U.S. Application Data
(60) Provisional application No. 63/506,696, filed on Jun. 7, 2023.

(51) Int. Cl. G06T 7/20; G06T 3/02; G06T 3/18; G06T 5/50; G06V 40/16

(52) U.S. Cl. CPC G06T 7/20; G06T 3/02; G06T 3/18; G06T 5/50; G06V 40/168; G06T 2207/20221

(57) ABSTRACT

A video generation facility is described. The facility captures an audio/video sequence of a person speaking that is made up of a sequence of frames and an audio track. The facility performs facial mapping for the frames in the captured audio/video sequence to produce a first facial mapping result, and facial mapping for an image or video sequence of the person to produce a second facial mapping result. For each frame of the captured audio/video sequence, the facility: (1) spatially correlates the frame with the image of the person using the first and second facial mapping results to produce spatial correlation results, and (2) merges first regions of the frame with second regions of the image of the person, using the spatial correlation results, to produce a merged frame. The facility then combines the audio track with the merged frames to obtain a resulting audio/video sequence.

### CROSS-REFERENCE TO RELATED APPLICATIONS

This application claims the benefit of U.S. Patent Application No. 63/506,696, filed Jun. 7, 2023 and entitled “GENERATIVE FACIAL MAPPING AND BODY BLENDING DURING VIDEO CAPTURE,” which is hereby incorporated by reference in its entirety.

In cases where the present application conflicts with a document incorporated by reference, the present application controls.

### BACKGROUND

Businesspeople commonly communicate using textual asynchronous digital communication modes such as email and text messages.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments to record, augment, and deliver a video message.

FIG. 3 is a data flow diagram showing data flows that occur in the operation of the facility in some embodiments.

FIG. 4 is a display diagram showing a sample display presented by the facility in some embodiments to record a video.

FIG. 5 is a display diagram showing a sample display presented by the facility in some embodiments to select a Halo photo or video sequence to use in the mapping and blending of the recorded video.

FIG. 6 is a display diagram showing a sample display presented by the facility in some embodiments in order to preview a version of the recorded video that has been mapped and blended by the facility with the selected Halo image.

FIG. 7 is a data flow diagram showing a machine learning pipeline used by the facility in some embodiments, including a variety of machine learning models.

FIG. 8 is a data flow diagram showing data flow within the TPSM model used in the machine learning pipeline in some embodiments and shown in FIG. 7.

FIG. 9 is a high-level data flow diagram showing the facility's use of the identity model for particular user in some embodiments.

FIG. 10 is a data flow diagram showing training of the identity model performed by the facility in some embodiments.

FIG. 11 is a data flow diagram showing a more detailed of the operation of the facility to perform mapping and blending of a recorded video with a Halo image or video in a way that is individualized with respect to each user's unique facial characteristics and expressions using the identity model.

### DETAILED DESCRIPTION

The inventors have recognized that human beings are wired to be social creatures and glean significant information from the tone, body language, eye-contact, and demeanor of someone we are interacting with face to face. Unfortunately, with the advent of computing, the internet, and mobile devices, people have shifted significant portions of our communication into digital forms that strip that social and visual information away. In the work environment in particular, companies send billions of e-mails and digital text messages every single hour-all of which rely on a raw text form to communicate effectively. Interestingly, the ability of people to capture and send asynchronous video as a superior, more emotive, more authentic communication channel has been available for decades but is rarely used today.

The inventors have recognized a number of gating factors that prevent users from recording asynchronous video, including workflow complexity, not knowing what to say, and not feeling confident about one's speaking ability. One of the biggest dampeners that prevents asynchronous video capture is the simple fact that, in many instances where a person is working on their computer or laptop, they simply aren't in a position where they are ready to be recorded in terms of their hair, makeup, clothing, or background environment.

Without being able to solve that issue, asynchronous video capture will always be significantly dampened, as it is difficult to break out of one's workflow in the moment and remember to come back to a message or topic in the future. The overwhelming majority of workers, when faced with that recording inability in-the-moment, will instead simply fall back to the easiest communication path by sending an asynchronous text-based message through whatever such system (e-mail, team-collaborative software, etc.) they were currently using.

By providing a solution to this need to be able to record a message ‘wherever and whenever a person is actually working, regardless of how they look and what they are wearing’, the inventors seek to close this behavior gap and bring more authentic, emotive digital correspondence to the world.

The inventors have identified numerous disadvantages of current methods of attempting to record asynchronous digital video messages by individuals given the wide range and variation in clothing, hair preparation, make-up, background, and lighting that a given person might be exhibiting at any given point in time. Conventional synchronous and asynchronous video recording systems attempt to alleviate gaps in these areas through a combination of filters, background changes, lighting changes, facial smoothing, and more. For example: (1) if the person is in the wrong lighting, they will be able to adjust that the color, contrast, or brightness of their lighting; (2) if the person isn't comfortable with their video recording background (e.g., the room that they are in) they can blur out or replace that background; (3) and if the person doesn't feel like they are prepared in terms of make-up, they can apply slight smoothing filters or adjustments. All of these methods, although useful, ultimately fail in environments where a person is simply not wearing the appropriate clothing or their hair/facial hair is compromised. A good example of this is a man, sitting in bed in his pajamas while working on his laptop, with unwashed and unkept hair, who is clearly not clean-shaven. No amount of lighting adjustment, background changes, or facial smoothing would allow that person to record a video in that moment and send it to another professional.

In response to the inventors' recognition of these disadvantages, they have conceived and reduced to practice a software and/or hardware facility (“the facility”) to perform generative facial mapping and body blending transformation during asynchronous video capture in a way that makes a speaker comfortable recording a message regardless of where they are, how they look, or what they are wearing.

In some embodiments, the facility is implemented as a mobile application installed on a smartphone, a desktop computer application installed on a desktop or laptop device that supports video capture, a browser or application plug-in installed on a video capture computing device, or a web-site accessed by any of the aforementioned video capture computing devices.

In some embodiments, the recommendation services include visual transformation services provided by third parties via defined Application Programming Interfaces (APIs) or proprietary first-party systems commonly owned and operated with the facility.

In some embodiments, the facility embeds a generative facial mapping and body blending transformation capability into a connected video-recording client that can be easily instantiated if needed but isn't required for the recording to be completed.

In some embodiments, the facility captures a baseline video from a user that includes all of the imperfections of their current environment (wrong background, wrong clothes, wrong hairstyle, etc.). The facility then offers an option to generatively combine that video with a previous video or image of that same person where those same elements were previously captured in an acceptable state (sitting at a desk while wearing a suit, speaking when hair is appropriately styled, etc.). The facility then blends these digital assets in a way that maintains all the facial expression, voice nuance, and emotion of the first video with the body (clothing, hair, facial hair, etc.) and environment (background) from the second video or image.

In some embodiments, the facility provides multiple options for which body/environment to merge the baseline video with (given that the user will have recorded multiple videos in the past through the facility). So for instance, the user is presented with an option to generatively combine the baseline video with a video or image previously taken while sitting at an office desk, or a video or image previously taken while sitting in the person's home office, or a video or image previously taken while sitting in a more natural, outdoor setting. In some embodiments, the facility expressly prompts the user to record an ‘acceptable’ video or image body/environment sample that can be used for any future blending. The facility merges the elements together, resulting in a single, merged video stream that can then be shared.

In some embodiments, with sufficient processing capability, the facility provides this blending functionality in real-time or near-real-time, allowing the user to get an instant view of the merged video stream.

In some embodiments, the facility uses an identity artificial intelligence model to perform its mapping and blending of a recorded video with a halo image or video and blending of a recorded video with a halo image or video in a way that is individualized with respect to each user's unique facial characteristics and expressions. The facility establishes a different instance of the identity artificial intelligence model for each user. For each user, the facility trains the user's instance of the identity model using one or more video sequences or audio/video sequences recorded by or of the user, to learn the user's facial characteristics and expressions to provide further accurate representation in the merged and blended audio/video sequence produced by the facility. In some embodiments, the identity model uses autoencoders or other similar techniques to learn a compressed representation of the subject user's face. In some embodiments, in the operation of the facility, the identity model interacts with one or more of a keypoint detection module, and encoder module, a motion capture module, and optical flow/transformation module, and an occlusion handling module to better adapt their processing to individual details of the user.

By performing in some or all of the ways described above, the facility makes it possible for a person to record a professional-looking video irrespective of their actual hair or makeup condition, clothing, or background environment. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. This is particularly true with respect to the facility's evaluation of multiple large machine learning models which require performance of massive volumes of highly-interrelated mathematical and/or logical operations.

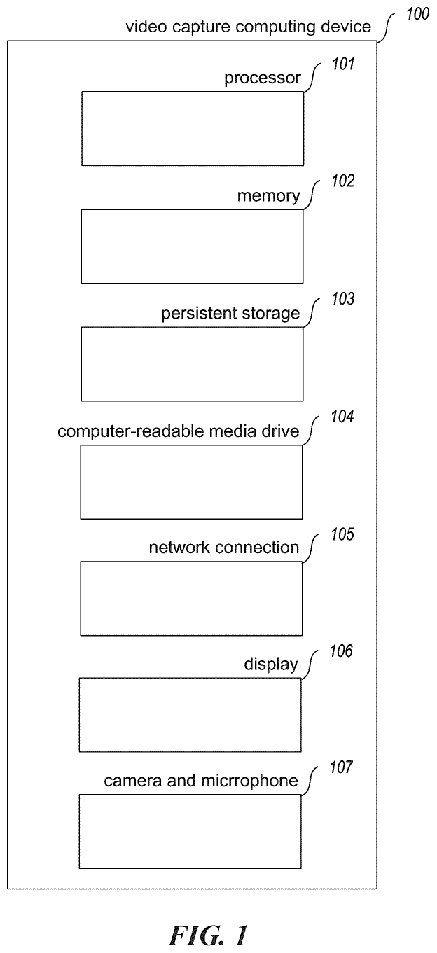

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like; a display 106 for displaying visual information or data to a user; and a video camera and audio capture device 107 for recording a visual and audio stream in real-time from a user. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

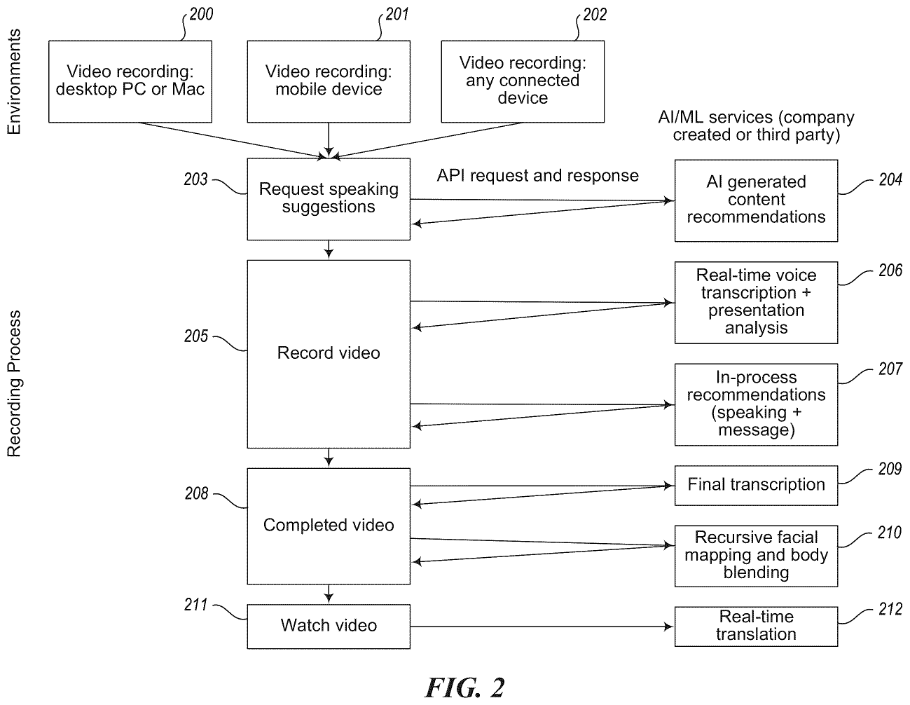

FIG. 2 is a flow diagram showing a process performed by the facility in some embodiments to record, augment, and deliver a video message. A user first triggers a video recording session in one of multiple connected computing environments, such as a desktop computer 200, a mobile device 201, or a generic connected computing device 202. In act 203, the facility prompts the user with the option to receive real-time speaking suggestions. In some embodiments, the user types or verbalizes a speaking help request into a text input form. In act 204, the facility takes the request inputs along with other unique context setting data and constraints and triggers a real-time call to a first- or third-party recommendation, algorithm, Large Language Model (LLM), or equivalent. In some embodiments, the facility makes this call to a Large Language Model such as GPT-3.5 or GPT-4 from Open AI, Inc. In some embodiments, request takes the form of an API call which includes the following parameters as of the date of this submission: (1) the specific model used; (2) the now modified request to be processed; (3) temperature/randomizer parameters to define the response range; (4) length restrictions for the final output; and (5) other parameters that impact the response range. A speaking recommendation is served back from the recommendation engine and then displayed by the instantiating device or client. In some embodiments, the facility's generation and presentation of this speaking recommendation script is as described in U.S. patent application Ser. No. 18/617,384 filed on Mar. 26, 2024, entitled “REAL-TIME AI-DRIVEN SPEAKING SUGGESTIONS DURING ASYNCHRONOUS VIDEO CAPTURE,” which is hereby incorporated by reference in its entirety.

In some embodiments, the user instantiates a video recording 205. The resulting video stream is interpreted in real-time by a set of first- or third-party services that extract the text transcript from the video and perform a real-time analysis of the visual presentation in terms of speaking confidence, tone, presence, clarity, and more 206. In some embodiments, the system sends back speaking or stylistic recommendations on how the user can improve their presentation 207. Once the video recording is stopped by the user 208 a final transcription is provided 209. In some embodiments, the user then chooses to transform this video 210 using a generative facial mapping and body blending function provided by the facility, which results in a new, blended video that maintains the facial and voice nuance of the originally recorded video, but merged with the background, hair, and body provided through a previously recorded video or previously captured image of the same individual. The user then sends this video to one or more recipients who then watch the video 211. In some embodiments, the recipient user reads the previously transcribed final transcription in parallel to watching the video or requests a real-time language translation into an alternative language, which is provided by a first- or third-party translation engine 211.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

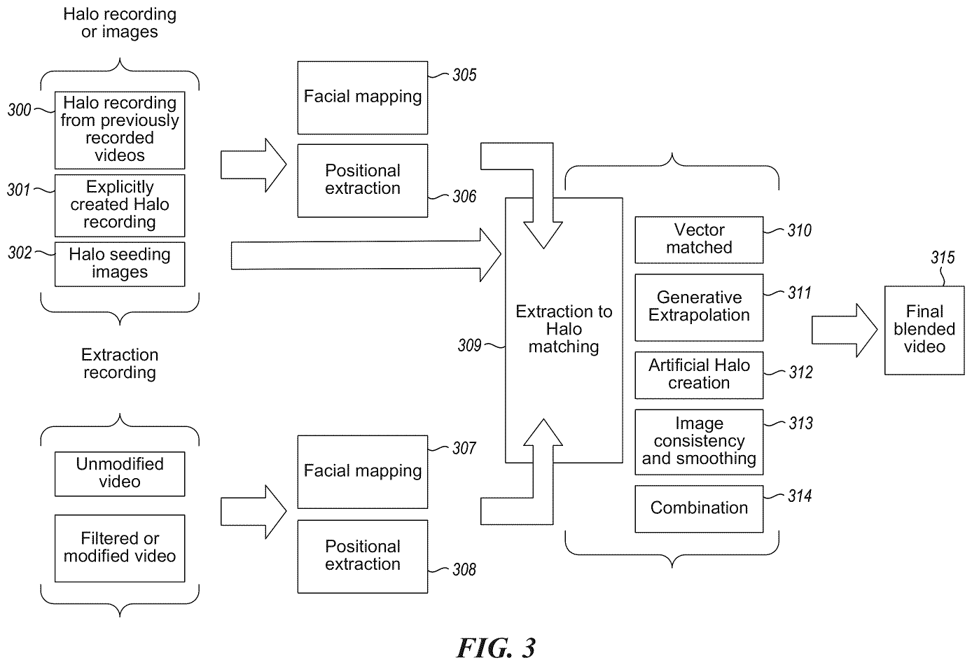

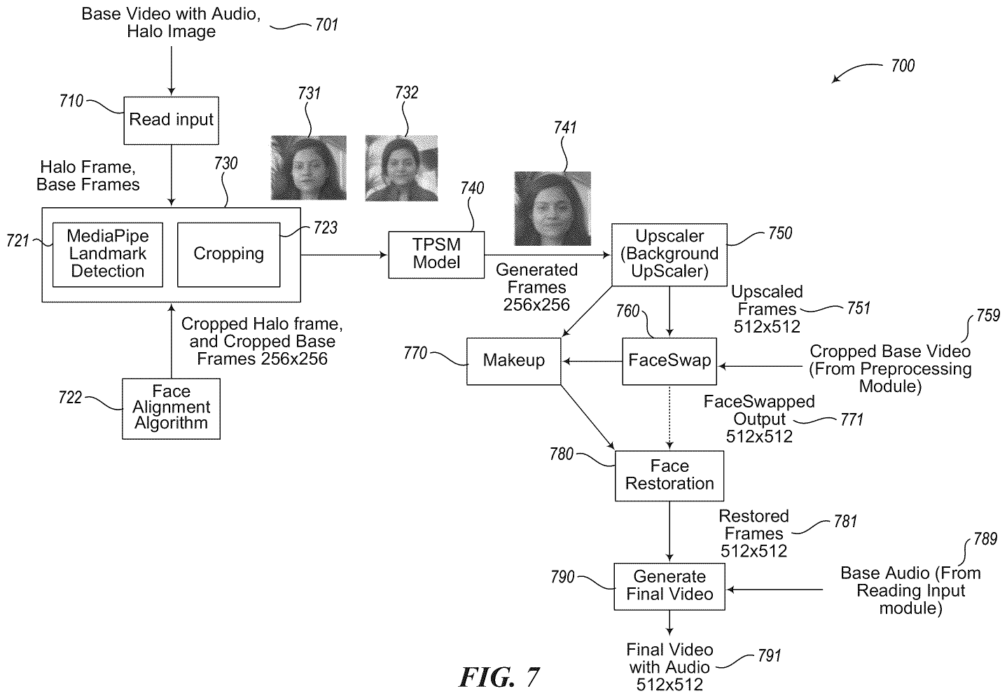

FIG. 3 is a data flow diagram showing data flows that occur in the operation of the facility in some embodiments. In particular, the data flow diagram shows processing performed by the facility to generatively combine the voice, facial movements, and expressions from the video being recorded (the “Extraction recording”) with the background, hair, and body of a receiving video or image in which elements like hair, makeup, clothing, and background are more suitable for the video (the “Halo recording” or “Halo image”). In various embodiments, the facility generates the Halo recording or image through one of multiple processes shown in FIG. 7, which include: the user selecting, or the system automatically recommending, a previously recorded video or image that the user has stored in the system 300; an explicit process by which a user is instructed to capture a detailed Halo recording 301, where the user may be prompted to perform various head and facial movements in order to capture a robust model at all possible angles; or 302 a simple static photo or series of photos that can serve as a baseline for the creation of a new generative Halo target. In various embodiments, once at least one Halo recording or image target has been stored in the system, the user triggers the facial mapping and body blending capability by selecting the appropriate interface option during a recording session. At that point, the user can record the Extraction video, which includes the key vocal message, facial expressions, and emotions that the user wants to maintain in the final blended message. In various embodiments, this video may be simply recorded and submitted as is 303, or it might be subject to the application of filters or facial smoothing 304.

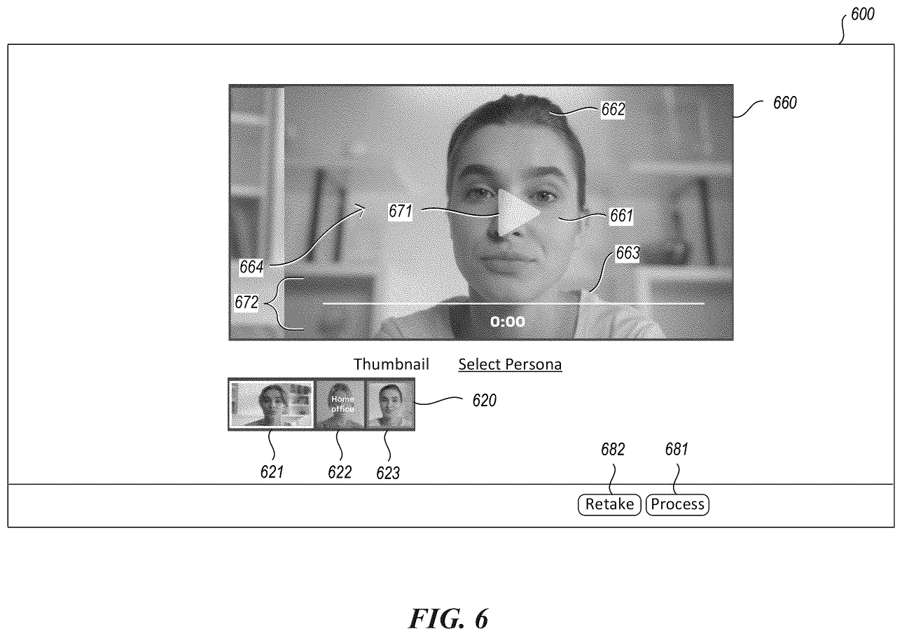

In various embodiments, the facility begins the process of blending the Extraction video target with the chosen Halo video or image. In order to perform that blending, the system maps and extracts the facial structure from the Halo video 305, including highly granular positional and vector data of the user's head position 306. Similarly, the system processes and maps the facial structure of the Extraction video 307, including the same level of granular positional and vector data of the user's head position 308. The facility then runs Halo recording or images through one or multiple potential matching algorithms or systems 309, either provided as part of the facility, licensed from third parties, or both. In various embodiments, those matching algorithms include, either individually or in combination, one or more of the following: (1) a vector matching approach that identifies head positions that are aligned between both videos 310; (2) a generative Artificial Intelligence algorithm that extrapolates the matching Halo frame for any given Extraction frame 311; (3) a completely artificial Halo creation that leverages or refers to the Halo recording but ultimately creates a purely digital, artificial proxy of the halo frame (e.g., a digital avatar halo) 312; (4) algorithms 313 that assist in this processing function-including algorithms that ensure color tones, contrast, brightness, smoothness and more were consistent across the full frame; or (5) a combination 314 of one, multiple, or all of these approaches. Finally, the facility renders a blended video 315 and provides it to the user for viewing, sharing, and distribution. Depending on which combination of approaches are used, this rendering may happen as a completely off-line process, or it may be rendered in real-time in a way that the video recorder can actually see in real-time what the final video FIG. 6 will look like.

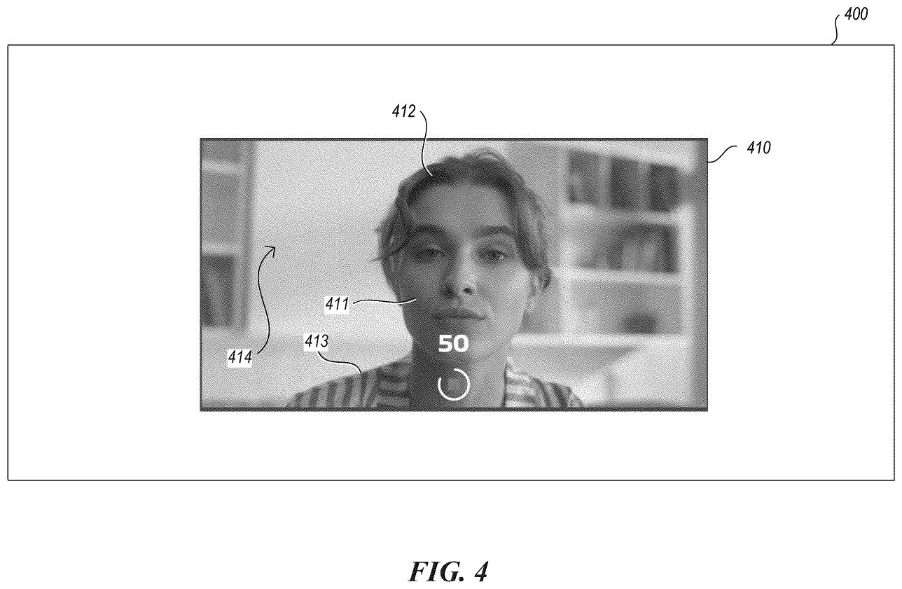

FIGS. 4-6 show an example of the facility performing the mapping and blending process for a sample recorded extraction video.

FIG. 4 is a display diagram showing a sample display presented by the facility in some embodiments to record a video. The display 400 includes a video recording window 410 showing the sequence of video frames being captured by the camera. The present frame shows aspects of the user, including the user's face 411, hair 412, and clothing 413. The frame also shows the visual background 414 behind the user. In some embodiments, the video window also includes controls for stopping, pausing, and unpausing the recording of the video as well as an indication of an amount of time elapsed or remaining for the video being recorded.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

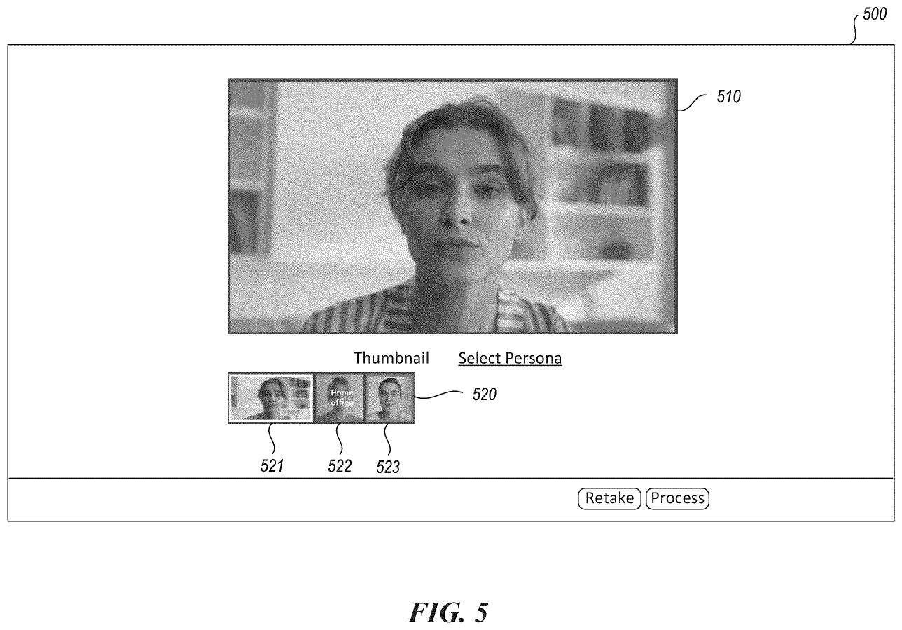

FIG. 5 is a display diagram showing a sample display presented by the facility in some embodiments to select a Halo photo or video sequence to use in the mapping and blending of the recorded video. The user can do this in a Halo selection area 520, which, in addition to a frame 521 of the recorded video, includes Halo images or videos 522 and 523, between which the user can select in order to choose hair, makeup, clothing, background, etc., to generatively combine into the recorded video. In this case, the user selects Halo image 523.

FIG. 6 is a display diagram showing a sample display presented by the facility in some embodiments in order to preview a version of the recorded video that has been mapped and blended by the facility with the selected Halo image. In particular, the blended video review window 660 includes a blended version 661 of the user's face; a blended version 662 of the user's hair; a substituted and/or blended version 663 of the user's clothing; and a substituted or blended version of the Halo background 664. The review window also includes controls 671 and 672 for navigating the duration of the video to review the results of the mapping and blending either throughout or at various discrete points. The user can activate a process control 681 in order to accept the mapped and blended video, such as by storing it persistently, transmitting it to a recipient, placing a copy or a pointer in one or more video inboxes, etc. The user can also activate a retake control 682 to re-record a recorded video.

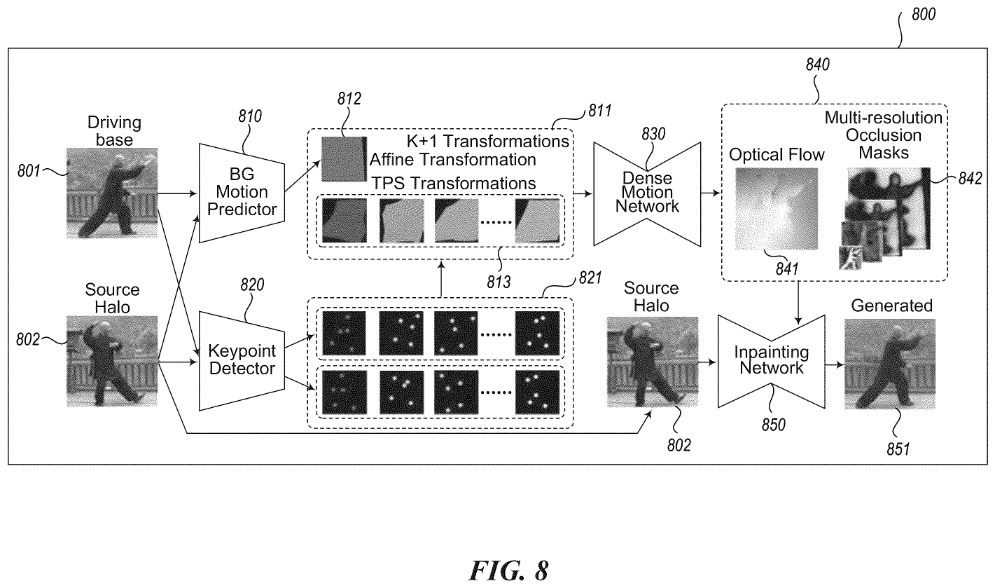

FIGS. 7 and 8 are data flow diagrams showing additional processing by the facility as part of the mapping and blending process.

FIG. 7 is a data flow diagram showing a machine learning pipeline used by the facility in some embodiments, including a variety of machine learning models. The pipeline 700 begins with input data 701 including the base video sequence and its audio, and a Halo image or video sequence. The facility reads 710 this input, to provide the one or more Halo frames, and the set of base frames from the extraction video (“base video”) 711. In stage 730, the facility applies the following processes to the Halo frame or frames and the base frames: MediaPipe landmark detection 721; face alignment 722; and cropping 723. Stage 730 produces a cropped Halo frame 731 and cropped base frame 732. In some embodiments, these frames are cropped to a resolution of 256×256. The facility subjects these cropped frames to a pluggable artificial intelligence model 740—such as a Thin Plate Spline Motion (“TPSM”) model or an adaptive super-resolution (AdaSR) model—to produce generated frames 741. The facility subjects these generated frames to a background upscaler 750 to produce upscaled frames 751. In some embodiments, the background upscaler is a deep network containing several residual-in-residual dense blocks, such as an Enhanced Super-Resolution Generative Adversarial Network (“ESRGAN”). In some embodiments, rather than using an ESRGAN discriminator, the facility substitutes a UNet discriminator that includes skip connections and/or performs spectral normalization regularization to the output of the discriminator. In some embodiments, the upscaled frames are at the larger resolution of 512×512.

The facility subjects these upscaled frames, together with the cropped base video 751, to a FaceSwap process 760 and Makeup Transfer process 770. In some embodiments, the facility uses components of a computer vision library such as OpenCV to perform the FaceSwap process. In some embodiments, the Makeup transfer process detects, extracts, and applies aspects of makeup such as the following, in some cases subsequently performing blending: lip makeup, eye makeup, and cheek makeup. The results of the FaceSwap and Makeup Transfer processes are subjected to a face restoration 780 module to perform a face restoration, producing final restored frames 781. A generate final video process 790 consumes these final restored frames, together with the audio from the base video sequence 789, to produce final video with audio 791.

FIG. 8 is a data flow diagram showing data flow within the TPSM model used in the machine learning pipeline in some embodiments and shown in FIG. 7. The TPSM model consumes the base video 801 recorded by the user—also called the “extraction video” or the “driving video”—as well as the Halo video or image 802—also called the source video or image. These two inputs are consumed by each of a background motion predictor 810 and a keypoint detector 820. The background motion predictor estimates the parameters of an affine transformation by modeling the motion of the background between the source and driving frames, compensating for camera-induced motion. In some embodiments, the background motion predictor is trained with loss functions, such as background loss, to ensure accurate background motion modeling. The keypoint detector predicts keypoints 821 or key features in both the S and D frames, estimating their (x,y) coordinates for use in motion estimation processes as control points for transformations. Among the K+1 transformations 811 is an affine transformation 812 that operates using the parameters estimated by the background motion predictor to perform a linear mapping that preserves points, straight lines, and ratios of distances between points. The parameters provided can include parameters for translation, rotation, scaling and shearing. The affine transformation is used by the facility to align and transform one image into another, capturing various types of geometric changes. The transformations 811 also include thin plate spline transformations 813, which are flexible, nonlinear transformations used to approximate complex motion. They are given keypoints detected in two corresponding images, and warp one image to the other with minimal distortion to approximate the mapping between the source image and the driving image. The facility subjects the results of these transformations to a dense motion network 830, which is an hourglass network used to estimate optical flow and multi-resolution occlusion masks. The facility uses the dense motion network to compute an optical flow that combines the result of the affine transformation and the KTPS transformations. The results 840 of the dense motion network are an optical flow 841, as well as multi-resolution occlusion masks 842 that indicate missing regions of feature maps. An inpainting network 850 receives the source frame 802 as well as the products 840 of the dense motion network to produce an output video sequence 851—also called an “generated video sequence.” The inpainting network warps feature maps using estimated optical flow and inpaints missing regions identified by the occlusion masks.

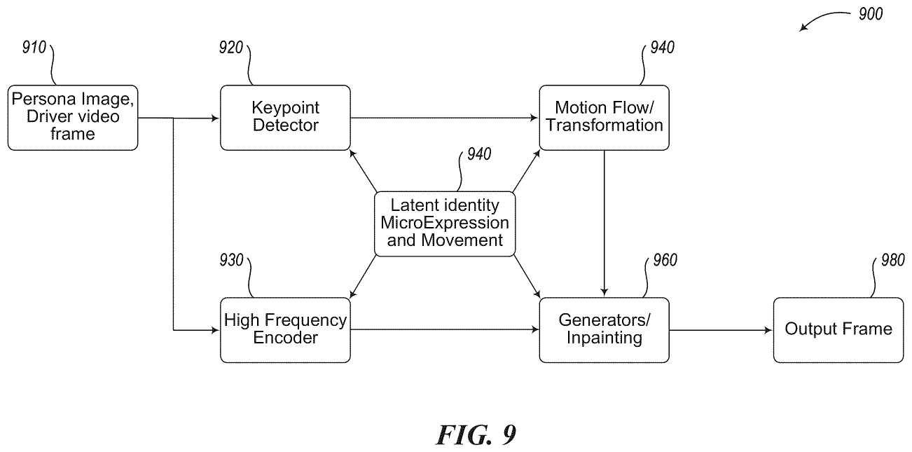

In some embodiments, the facility uses an identity artificial intelligence model to perform its mapping and blending of the extraction video with a Halo image or video in a way that is individualized with each user's unique facial characteristics and expressions. FIG. 9 is a high-level data flow diagram showing the showing the facility's use of the identity model for a particular user in some embodiments. The data flow 900 begins with inputs 910: a Halo (“persona”) image showing the user as they wish to appear in the video, and a frame of the driver video whose speech the user wants to include in the video message being created. The inputs flow to a keypoint detector module 920 and a high frequency encoder module 930. The keypoint detector module identifies key facial points like the corners of eyes, mouth, and nose in both the source and target images. These points act as landmarks for tracking facial features during the transfer process performed by the motion flow/transformation module. In various embodiments, the facility implements the keypoint detector using techniques such as convolutional neural networks that are trained on large facial image data sets. The encoder analyzes high-frequency details in the source face image; these can include textures, wrinkles, and skin blemishes, for example. Such details are useful to preserve the source face's identity during application of new poses and expressions merged from the driver video frame. In some embodiments, the facility implements the high frequency encoder using convolutional neural networks designed to capture intricate patterns and images.

The latent identity module 940 encodes the source face's unique identity, based upon its training using videos and/or images of the source face. This latent representation is used by the facility to better preserve individual facial characteristics during the transfer performed by the motion flow/transformation module. In some embodiments, the latent identity module uses autoencoders that learn a compressed representation of the source face.

The outputs of the high frequency encoder, latent identity module, and motion flow/transformation module feed to a generator/inpainting module 960, which generates the final image (output frame) 980 with transferred pose and expression. In particular, the generator/inpainting module synthesizes a realistic image that blends the source identity with the target pose and expression. In some embodiments, it also includes inpainting techniques to fill in inconsistencies arising from the transfer process.

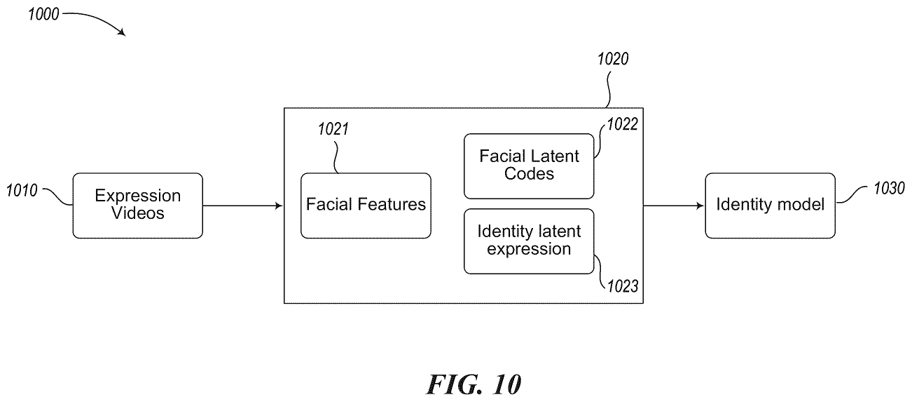

FIG. 10 is a data flow diagram showing training of the identity model performed by the facility in some embodiments. In the data flow 1000, one or more expression videos 1010 flow into an identity model training module 1020. The identity model training module extracts from the expression videos facial features 1021, facial latent codes 1022, and identity latent expression 1023, which it uses to train identity module 1030 in a way that adds the individual's unique characteristics to the identity model. In some embodiments, the facility integrates into this representation external landmarks for facial movements such as pupil and iris movements of the eye, to enrich the identity profile. In some embodiments, the facility selects and/or commissions the expression videos to encompass a variety of one or more different factors, including poses-head rotations (up and down, and to the left and right), tilts, and various angles; expression-facial expressions including happiness, sadness, anger, surprise, disgust, fear, and neutral; lighting conditions, such as bright, dim, natural, and artificial to account for potential shadows and highlights; and scenarios-various activities or conversations to capture nature expressions and subtle muscle movements arising under a variety of conditions. In some embodiments, the training process encodes into the identity module facial features such as facial geometry; the specific shape and proportions of the face, including distances between eyes, nose size and shape, lip shape, etc.; wrinkles and scars—these or other kinds of permanent markings on the face, which help maintain a realistic representation; and muscle movements—how the individual's facial muscles move during different expressions, capturing subtle nuances in their movement patterns.

In some embodiments, the facility performs a two-phased training process with respect to the identity model. In a first phase, the facility trains the identity model based upon automatically detected images and/or videos of a wide variety of people, such as those provided as part of a third-party video dataset. In a second phase, the facility further trains the model based upon key points in images in videos showing a particular person for whom the identity model is to be used.

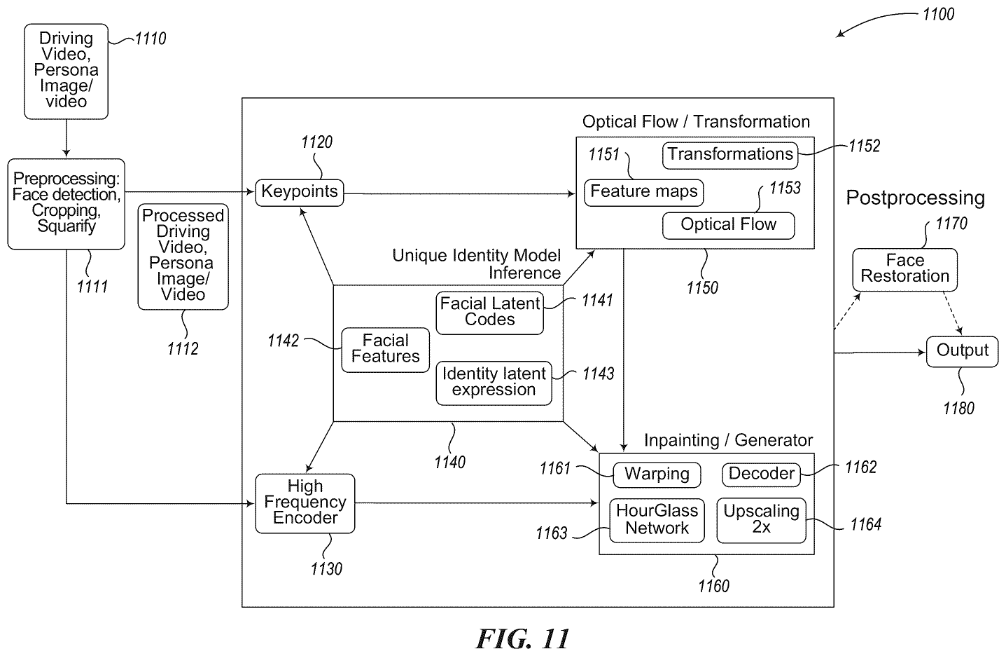

FIG. 11 is a data flow diagram showing a more detailed of the operation of the facility to perform mapping and blending of a recorded video with a Halo image or video in a way that is individualized with respect to each user's unique facial characteristics and expressions using the identity model. In the shown flow 1100, input data 1110 includes a driving video containing the speech intended for the video message, together with a Halo/persona image or video flows to a preprocessing module 1111. The preprocessing module performs preprocessing functions including face detection, cropping, and squarification to produce processed input data 1112. These processed inputs flow to a keypoint detector module 1120, and a high frequency encoder module 1130. The keypoint detection module performs feature expression extraction, such as by using a Thin Plate Spline Motion (TPSM) and/or adaptive super-resolution (AdaSR) artificial intelligence model. It identifies and tracks a potentially large number—such as 700—keypoints on the face, in some cases capturing details such the corners of eyes, lips, and brow movements. In some embodiments, the keypoint detection module integrates external landmark detection that captures micro expressions and specific movements beyond facial features, such as iris movement. The output of the keypoint detection module flows to an optical flow/transformation module 1150.

The high frequency encoder analyzes high-frequency details in the face such as textures, wrinkles, and skin blemishes, such as by using one or more convolutional neural networks. The output of the high frequency encoder module flows to an inpainting/generator module 1160.

A latent identity module 1140 provides user specific information for assistance of one or more of the following modules: the keypoint detection module, the high frequency encoder module, the optical flow/transformation module, and the inpainting/generator module. It encodes information such as a facial latent codes 1141, facial features 1142, and identity latent expression 1143 for the user to whom it is tailored.

The optical flow transformation module uses feature maps 1151, transformations 1152, and optical flow 1153 to map movement in the driving video providing its output to the inpainting/generator module.

The inpainting/generator module 1160 is responsible for generating the output video 1180. It fuses movement data from the motion capture, optical flow/transformation module, and identity specific information from the identity learning module to create a comprehensive representation, and uses deep learning to perform high-quality image synthesis. In some embodiments, the image generation module also receives identity feature information from the identity model inference module to guide accurate feature placement. This helps maintain accurate scene realism in the final animation. In some embodiments, the inpainting/generator module includes submodels for warping 1161, decoding 1162, an hourglass network 1163, and resolution upscaling 1164. In some embodiments, the facility includes a face restoration module 1170 to perform post processing on the result video outputted by the inpainting/generator module.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system having a display device and a camera, the method comprising:
with the camera, capturing an audio/video sequence of a person speaking, the captured audio/video sequence comprising a sequence of frames and an audio track;
causing presentation on the display of a plurality of images of the person;
receiving input selecting one of the plurality of images;
performing facial mapping for the frames in the captured audio/video sequence to produce a first facial mapping result;
performing facial mapping for the selected image to produce a second facial mapping result;
for each frame of the captured audio/video sequence:
spatially correlating the frame with the selected image using the first and second facial mapping results to produce spatial correlation results;
merging first regions of the frame with second regions of the selected image, using the spatial correlation results, to produce a merged frame; and
combining the audio track with the merged frames to obtain a resulting audio/video sequence.

2. The method of claim 1 wherein the first regions comprise at least one region containing the mouth of the person,
and wherein the second regions comprise at least one region containing one or more of hair of the person, clothing worn by the person, makeup applied to the person, and surroundings of the person.

3. The method of claim 2 wherein the first regions comprise at least one region collectively containing the eyes, cheeks, and mouth of the person.

4. The method of claim 1, further comprising:
for each frame of the captured audio/video sequence:
before the merging, applying a geometric transformation to warp the selected image to more closely match a shape and size of the person's face in the frame using the spatial correlation results.

5. The method of claim 1 wherein the merging comprises Poisson blending or alpha blending.

6. The method of claim 1, further comprising causing presentation on the display of at least a portion of the resulting audio/video sequence.

7. The method of claim 1, further comprising persistently storing the resulting audio/video sequence.

8. The method of claim 1, further comprising:
receiving input specifying a recipient; and
causing the resulting audio/video sequence to be added to a video inbox of the recipient.

9. The method of claim 1 wherein the merging uses output of an identity module trained with video captured of the person.

10. The method of claim 1, further comprising:
receiving input specifying a recipient; and
causing an email message to be transmitted to the recipient that contains a link to the resulting audio/video sequence.

11. One or more computer memories collectively storing a data structure, the data structure representing an audio/video sequence related to both a source audio/video sequence showing a person speaking and an image of the person that is separate from the source audio/video sequence, the data structure comprising:
first information specifying a video sequence of the audio/video sequence represented by the data structure, the video sequence comprising frames, at least a distinguished portion of the frames of the video sequence depicting the person's face, each of the frames of the distinguished portion comprising:
one or more first regions matching one or more corresponding first regions of a corresponding frame of the source audio/video sequence; and
one or more second regions matching one or more corresponding regions of the image; and
second information specifying an audio sequence of the audio/video sequence represented by the data structure that corresponds to the audio portion of the source audio/video sequence,
such that the audio/video sequence represented by the data structure depicts the person delivering the speech of the source audio/video sequence, with visual aspects of the image of the person combined with visual aspects of the video sequence of the source audio/video sequence.

12. The one or more computer memories of claim 11 wherein the one or more first regions contain the person's mouth,
and wherein the one or more second regions contain one or more of hair of the person, clothing worn by the person, makeup applied to the person, and surroundings of the person.

13. One or more instances of computer-readable media collectively having contents configured to cause a computing system to perform a method, the method comprising:
capturing an audio/video sequence of a person speaking, the captured audio/video sequence comprising a sequence of frames and an audio track;
performing facial mapping for the frames in the captured audio/video sequence to produce a first facial mapping result;
performing facial mapping for an image of the person to produce a second facial mapping result;
for each frame of the captured audio/video sequence:
spatially correlating the frame with the image of the person using the first and second facial mapping results to produce spatial correlation results;
merging first regions of the frame with second regions of the image of the person, using the spatial correlation results, to produce a merged frame; and
combining the audio track with the merged frames to obtain a resulting audio/video sequence.

14. The one or more instances of computer-readable media of claim 13 wherein the first regions comprise at least one region containing the mouth of the person, and wherein the second regions comprise at least one region containing one or more of hair of the person, clothing worn by the person, makeup applied to the person, and surroundings of the person.

15. The one or more instances of computer-readable media of claim 13, the method further comprising:
for each frame of the captured audio/video sequence:
before the merging, applying a geometric transformation to warp the selected image to more closely match a shape and size of the person's face in the frame using the spatial correlation results.

16. The one or more instances of computer-readable media of claim 15 wherein the geometric transformation uses one or more of an affine transformation, a thin plate spline transformation, or both an affine transformation and a thin plate spline transformation.

17. The one or more instances of computer-readable media of claim 13 wherein the spatial correlation uses a keypoint detection technique.

18. The one or more instances of computer-readable media of claim 13 wherein the merging comprises Poisson blending or alpha blending.

19. The one or more instances of computer-readable media of claim 13, the method further comprising causing presentation on the display of at least a portion of the resulting audio/video sequence.

20. The one or more instances of computer-readable media of claim 13, the method further comprising:
receiving input specifying a recipient; and
causing an email message to be transmitted to the recipient that contains a link to the resulting audio/video sequence.

21. The one or more instances of computer-readable media of claim 13 wherein the spatial mapping for the frames, spatial correlation, and merging our performed substantially in real-time with respect to the capturing.

22. The one or more instances of computer-readable media of claim 21, further comprising transmitting the resulting audio/video sequence as one side of a live audio/video conversation.

23. The one or more instances of computer-readable media of claim 13 wherein the merging uses output of an identity module trained with video captured of the person.

24. (canceled)

25. (canceled)

26. One or more computer memories collectively storing an identity model data structure, the data structure relating to a person, the data structure comprising:
contents produced by training the identity model with video sequences each showing the person speaking, the contents comprising:
first contents encoding facial features of the person reflected in the video sequences;
second contents encoding facial latent codes for the person reflected in the video sequences; and
third contents encoding identity latent expressions of the person reflected in the video sequences,
such that the contents of the data structure are usable to assist the merging of an audio/video sequence of the person speaking with a halo image or video of the person.

27. The one or more computer memories of claim 26, the contents further comprising:
fourth contents encoding eye movement patterns of the person reflected in the video sequences.

28. The one or more computer memories of claim 26, the contents further comprising any of:
fourth contents encoding facial geometry of the person reflected in the video sequences;
fifth contents encoding wrinkles, scars, or wrinkles and scars of the person reflected in the video sequences; and
sixth contents encoding muscle movements of the person reflected in the video sequences.
